(19) United States
(12) Patent Application Publication
(10) Pub. No.: US 2017/0033354 A1
(43) Pub. Date: Feb. 2, 2017

(54) POSITIVE ELECTRODE MATERIAL, METHOD FOR PREPARING THE SAME AND LI-ION BATTERY CONTAINING THE POSITIVE ELECTRODE MATERIAL

(71) Applicant: Ningde Contemporary Amperex Technology Limited, Ningde City (CN)

(72) Inventors: Dingshan RUAN, Ningde City (CN); Miaomiao REN, Ningde City (CN); Xuguang GAO, Ningde City (CN); Qifeng LI, Ningde City (CN); Na LIU, Ningde City (CN); Yongshou LIN, Ningde City (CN)

(73) Assignee: Ningde Contemporary Amperex Technology Limited, Ningde City (CN)

(21) Appl. No.: 14/869,990

(22) Filed: Sep. 29, 2015

(30) Foreign Application Priority Data
Jul. 28, 2015 (CN) 201510449404.3

(51) Int. Cl. H01M 4/36; H01M 4/505; H01M 10/0525; H01M 4/525

(52) U.S. Cl. CPC H01M 4/366; H01M 4/525; H01M 4/505; H01M 10/0525; H01M 2220/20

(57) ABSTRACT

The present application provides a positive electrode material, a method for preparing the same and a Li-ion battery containing the positive electrode material, wherein, the positive electrode material is represented as Li₁₊ₓNiₐCo_{b}Mn_{c}M_{d}O₂, in which M is selected from one or more of Mg, Ti, Zn, Zr, Al and Nb. The positive electrode material provided by the present application has a small crystal volume and a small Li—Ni synchysis degree. In addition, after the positive electrode material provided by the present application is applied to a Li-ion battery, the Li-ion battery possesses a better cycle performance, a higher initial charge-discharge efficiency and a better power property. Moreover, in the present application, a precursor is prepared by a coprecipitation method, and then the precursor is sintered together with a Li source and a metal oxide to obtain the positive electrode material. This preparation method is simple and easy to implement with low costs, and can be applied in industrial manufacture on a large scale.

### TECHNICAL FIELD

The present application relates to the field of Li-ion battery, and particularly to a positive electrode material, a method for preparing the same and a Li-ion battery containing the positive electrode material.

### BACKGROUND

A ternary positive electrode material of secondary particles is formed by bonding numerous monocrystal granules, thus forming a lot of crystal boundaries. Since different monocrystals have different crystal orientations, expansion and shrinkage during the cycle process are not consistent, which is macroscopically represented as fracture at the crystal boundary and occurrence of many new interfaces, which will affect the storage and cycle performances of the cell. Moreover, the particles of the ternary positive electrode material will also crush during the cycling process, thus causing large expansion of the electrode, and finally threatening the entire safety of the cell.

However, ternary positive electrode materials are being studied by people more and more widely due to its higher energy density. Furthermore, the demand on the energy density of a battery system is higher and higher with the rapid development of electric vehicles.

Nevertheless, the existing ternary positive electrode materials have some defects that cannot be overcome in the prior art.

For example, ternary positive electrode materials NCM333 and NCM424, in which Ni and Mn are equal in proportion, have relatively better structural stability and thus are widely applied. However, they still cannot meet the requirements in vehicle industry. Ternary positive electrode materials NCM523 and NCM622 have a high energy density and thus application thereof is also extremely urgent, but NCM523 and NCM622 have a phase change in structure during the cycling process, i.e., generation of Rock-Salt, which leads to fast deterioration of cycle; in addition, the initial efficiency of such materials with a high content of Ni is very low, causing an increase of the overall weigh of the cell, which is not beneficial to improve the overall energy intensity.

### SUMMARY OF THE INVENTION

In order to solve the above problem, the applicant did related study and discovered that a positive electrode material, Li₁₊ₓNiₐCo_{b}Mn_{c}M_{d}O₂, with excellent performance was prepared by firstly preparing a precursor of the positive electrode material by a coprecipitation method and then sintering the precursor with a Li source, or a coated material with excellent performance was prepared by sintering the precursor with the Li source followed by coating with a metal oxide, thereby accomplishing the present application.

An object of the present application is to provide a positive electrode material containing a crystal with a superlattice structure having a chemical composition as shown by Formula I:

Li₁₊ₓNiₐCo_{b}Mn_{c}M_{d}O₂ Formula I

in which, −0.01≦x≦0.2, 1.8≦a/c≦2.2, 0.9≦b/c≦1.1, 0≦d≦0.1; and M is selected from at least one of Mg, Ti, Zn, Zr, Al and Nb.

Another objet of the present application is to provide a method for preparing a positive electrode material, comprising at least the following steps of:

a) adjusting a pH of a solution containing Ni, Mn and Co ions to 10-12, stirring under a temperature of 40° C.-70° C., separating, washing and drying to obtain a precursor;
b) evenly mixing a compound containing a Li source and a M source with the precursor obtained in step a), and sintering at a temperature of 820° C.-1000° C.;
c) smashing a sample obtained after sintering in step b) to obtain a sample having an average particle diameter D50 of 2-10 um by sieving, and performing tempering treatment to the sample obtained by sieving at a temperature of 500° C.-900° C.;
d) sieving the sample obtained after the tempering treatment in step c) to obtain a sample having an average particle diameter D50 of 2-10 um, i.e., the positive electrode material.

Another object of the present application is to provide a method for preparing a positive electrode material, comprising at least the following steps of:

a) adjusting a pH of a solution containing Ni, Mn and Co ions to 10-12, stirring under a temperature of 40° C.-70° C., separating, washing and drying to obtain a precursor;
b) evenly mixing a compound containing a Li source and a M source with the precursor obtained in step a), and sintering at a temperature of 820° C.-1000° C.;
c′) smashing a sample obtained after sintering in step b) to obtain a sample having an average particle diameter D50 of 2-10 um by sieving, and performing coating treatment to the sample obtained by sieving;
d′) performing tempering treatment to the sample obtained after the coating treatment in step c′) at a temperature of 500° C.-900° C.;
e) sieving the sample obtained after the tempering treatment in step d′) to obtain a sample having an average particle diameter D50 of 2-10 um, i.e., the positive electrode material.

Still another object of the present application is to provide a Li-ion battery, comprising at least one of a positive electrode material provided in the present application and a positive electrode material prepared by the method provided in the present application. The positive electrode material provided in the present application has excellent structural stability, has little or no crystal boundary in the particles, and has a low probability of particle breakage. In addition, the positive electrode material provided in the present application has a small crystal volume change and a small Li—Ni synchysis degree. Use of the positive electrode material provided by the present application in a Li-ion battery can improve the cycle performance and initial charge-discharge efficiency of the Li-ion battery.

Moreover, the preparing process used in the method for preparing the positive electrode material in the present application is simple and easy to implement with low costs, and can be applied in industrial manufacture on a large scale.

### DESCRIPTION OF DRAWINGS

FIG. 1 is a XRD spectrogram of the positive electrode material D1 obtained in Example One;

FIG. 2 is a XRD spectrogram of the positive electrode material NCM523 obtained in Comparison Example One;

FIG. 3 is a SEM photograph of the positive electrode material D1 obtained in Example One;

FIG. 4 is a SEM photograph of the positive electrode material NCM523 obtained in Comparison Example One;

FIG. 5 is a SEM photograph of the Li-ion battery 1 after a process of 50 times of cycles;

FIG. 6 is a SEM photograph of the Li-ion battery 10 after a process of 50 times of cycles.

### SPECIFIC EMBODIMENTS

The features and advantages of the present application will become clearer and more apparent from the following detailed description made to the present application. According to an aspect of the present application, a positive electrode material is provided. The positive electrode material is represented by the following formula I:

Li₁₊ₓNiₐCo_{b}Mn_{c}M_{d}O₂ Formula I

in which, when d is not 0, M is selected from one or more of the following metallic elements: Mg, Ti, Zn, Zr, Al and Nb.

Specifically, M is preferably one or more of Mg, Zn, Zr, Al and Nb, M is more preferably one or more of Zn, Zr, Al and Nb, and M is most preferably one or more of Zr and Al.

Element analysis was performed to the positive electrode material represented by the following formula I, and the result was: −0.01≦X≦0.2, 0≦d≦0.1, 1.8≦a/c≦2.2, 0.9≦b/c≦1.1.

Particularly, in the above formula I, X is 0.08.

In the above formula I, since a/c is 1.8-2.2, existence of superlattice in the obtained positive electrode material is guaranteed.

After XRD detection, the existing superlattice structure is a superlattice structure of [\sqrt{3}×\sqrt{3}]R30° type, and due to the existence of the superlattice, the cycle life of the positive electrode material is obviously improved. Particularly, a/c=2.

Particularly, the positive electrode materials provided in the present application may be listed as blow:

when d is 0, a is 0.5, b is 0.25, c is 0.25; X is 0.08.
when d is not 0, a is 0.495, b is 0.2475, c is 0.2475, d is 0.01; X is 0.08.
when d is not 0, a is 0.495, b is 0.2375, c is 0.2575, d is 0.01; X is 0.08.
when d is not 0, a is 0.475, b is 0.2375, c is 0.2575, d is 0.03; X is 0.08.
when d is not 0, a is 0.505, b is 0.2475, c is 0.2375, d is 0.01; X is 0.08.

In the above Formula I, it was found after X-ray Photoelectron Spectroscopy (XPS) detection that the nickel element was represented as Ni²⁺ and Ni³⁺; in addition, manganese element is represented as Mn⁴⁺, and cobalt element is represented as Co³⁺. In the positive electrode material represented by Formula I, the molar ratio of Ni²⁺ to Ni³⁺ is Ni²⁺/Ni^{3P}=0.9-1.1:1. Particularly, the molar ratio of Ni²⁺ to Ni³⁺ is Ni²⁺/Ni³⁺=1:1.

In the positive electrode material represented by Formula I, when the molar ratio of Ni²⁺ to Mn⁴⁺ is Ni²⁺/Mn⁴⁺=0.9-1.1:1, it can be guaranteed that manganese element does not have redox reaction during the charge and discharge process. Particularly, Ni²⁺/Mn⁴⁺=1:1.

In the positive electrode material represented by Formula I, when the molar ratio of Ni³⁺ to Co³⁺ is Ni³⁺/Co³⁺=0.9-1.1:1, it can be guaranteed that the lattice has a minimum volume change. Particularly, Ni³⁺/Co³⁺=1:1.

The positive electrode material provided in the present application is a kind of crystal structure. With an X-ray diffraction test, the specific peak position and intensity of the diffraction peak of the positive electrode material are as below: peak (003) of a layered characteristic peak 18.68° and peak (104) of 44.52°, and a series of small peaks of superlattice characteristic peaks 20-25°. It was known from the X-ray diffraction test that the positive electrode material provided in the present application contains a superlattice structure, the positive electrode material, when applied in a Li-ion battery, can improve the cycle performance of the Li-ion battery.

It was known from a particle distribution detection that the positive electrode material provided in the present application has an average particle diameter D50 of 2-10 um. The average particle diameter D50 of primary particles and the average particle diameter D50 of secondary particles of the positive electrode material provided in the present application were obtained from a co-detection of scanning electron microscope (SEM) and particle size test, wherein, the average particle diameter D50 of primary particles of the positive electrode material was recorded as D₁, and the average particle diameter D50 of secondary particles was recorded as D₂, the ratio of the average particle diameter D50 of primary particles of the positive electrode material to the average particle diameter D50 of secondary particles was D₁/D₂=0.5-1. Since the average particle diameter of primary particles/the average particle diameter of secondary particles is 0.5-1, crystal orientation inconsistency is avoided, thereby solving the problem that particles break during the cycle process after the positive electrode material is applied to a Li-ion battery.

In the present application, primary particles are single fine crystal particles, and secondary particles are agglomerated particles.

Particularly, the average particle diameter D50 of primary particles/the average particle diameter D50 of secondary particles of the positive electrode material is greater than 0.5 and less than 1.

In a preferred embodiment, it is known from an Energy dispersive X-ray spectra (EDS) detection that there is a coating layer outside the positive electrode material having a superlattice structure. Wherein, the specific types of the materials involved in the coating layer are not particularly defined, and they can be selected based on requirements.

In a preferred embodiment, the coating layer includes at least one of aluminium oxide, silicon oxide, boron oxide, tungsten oxide, zirconium oxide, titanium oxide, aluminum fluoride and magnesium fluoride.

In a preferred embodiment, it is known from an element analysis detection that the content of the coating layer is 0.03-1% of the total weight of the entire material before coating.

According to another aspect of the present application, a method for preparing a positive electrode material is provided, the method comprising at least the following four steps:

In step a), the pH of a solution containing Ni, Mn and Co ions is adjusted to 10-12, the solution is stirred under a temperature of 40° C.-70° C., separated, washed and dried to obtain a precursor.

In a preferred embodiment, a nickel salt, a manganese salt and a cobalt salt are added into a solvent to prepare a solution.

In the above preferred embodiment, the nickel salt is a soluble nickel salt. The specific types of the nickel salt are not particularly defined, and they can be selected based on practical requirements.

In a preferred embodiment, the nickel salt is one or more of nickel sulfate, nickel nitrate and nickel chloride.

In a further preferred embodiment, the nickel salt is one or more of nickel sulfate and nickel nitrate. Further, the nickel salt is nickel sulfate.

In the above preferred embodiment, the manganese salt is a soluble manganese salt. The specific types of the manganese salt are not particularly defined, and they can be selected based on practical requirements.

In a preferred embodiment, the manganese salt is one or more of manganese sulfate, manganese nitrate and manganese chloride.

In a further preferred embodiment, the manganese salt is one or more of manganese sulfate and manganese nitrate. Further, the manganese salt is manganese sulfate.

In the above preferred embodiment, the cobalt salt is a soluble cobalt salt. The specific types of the cobalt salt are not particularly defined, and they can be selected based on practical requirements.

In a preferred embodiment, the cobalt salt is one or more of cobalt sulfate, cobalt nitrate and cobalt chloride.

In a further preferred embodiment, the cobalt salt is one or more of cobalt sulfate and cobalt nitrate. Further, the cobalt salt is cobalt sulfate.

In the above preferred embodiments, the solvent is not particularly defined, provided that it can dissolve the nickel salt, the manganese salt and the cobalt salt.

In a preferred embodiment, the solvent is water. Water may be selected from one or more of the following: deionized water, distilled water, mineral water and tap water.

In a preferred embodiment, the nickel salt, the manganese salt and the cobalt salt are added in such amounts that the molar ratio of Ni element, Mn element and Co element in the solution is Ni:Co:Mn=a:b:c, in which a/c is 1.8-2.2 and b/c is 0.9-1.1.

In the above preferred embodiments, the concentration of the solution is not particularly defined, and can be adjusted according to practical requirements.

In the step a), ammonia water and sodium hydroxide are added into the solution containing nickel ions, manganese ions and cobalt ions to obtain a reaction system containing a precursor of the positive electrode material.

In a preferred embodiment, ammonia water and an aqueous solution of sodium hydroxide is fed into the solution containing nickel ions, manganese ions and cobalt ions.

In the above step a), the concentration of the ammonia water fed into the solution is not particularly defined, and can be selected according to practical requirements.

In a preferred embodiment, the concentration of the ammonia water is 0.1-2 mol/L. Further, the concentration of the ammonia water is preferably 0.3-1.5 mol/L. Further, the concentration of the ammonia water is preferably 0.5-1 mol/L. In the above step a), the concentration of the aqueous solution of sodium hydroxide fed into the solution is not particularly defined, and can be selected according to practical requirements.

In a preferred embodiment, the concentration of the aqueous solution of sodium hydroxide is 0.5-10 mol/L. Further, the concentration of the aqueous solution of sodium hydroxide is preferably 0.8-7 mol/L. Still further, the concentration of the aqueous solution of sodium hydroxide is preferably 1-5 mol/L.

In the above step a), the ammonia water fed into the solution is a complexing agent, and the aqueous solution of sodium hydroxide fed into the solution is used to adjust the pH of the reaction system and ensure that the pH of the reaction system is 10-12, thereby facilitating generation of a coprecipitate of hydroxide.

It was discovered by the applicant through studies that if pH is low, it is beneficial to crystal nucleus growth, but primary crystal particles are thick and large, whereas if pH is high, it is beneficial to crystal nucleus formation, but primary crystal particles are formed in flakes and seem to be very thin. In addition, as to the influence to secondary particles, if pH is very low, secondary particles tend to agglomerate, thus causing formation isomerism of secondary spheres; if pH is too high, secondary particles form spheres, but are hard to control, and the shaped and size of the particles are hard to control.

In the above step a), the temperature of the reaction system is 40-70° C. C. Further, the temperature of the reaction system is 45-65° C. C. Still further, the temperature of the reaction system is 50-60° C. C.

It was discovered by the applicant through studies that a high temperature leads to a high reaction speed, which causes the precursor to be oxidized easily, and phenomenon, such as the reaction process being hard to control and the precursor changing in structure, occur. In the above step a), the reaction time is not particularly defined, and can be selected according to practical requirements.

In the above step a), the stirring manner is not particularly defined, provided that the reaction system can be stirred evenly. Particularly, mechanical stirring is selected. After the above step a), a precursor of the positive electrode material is obtained. In the above step a), the detergent for washing the precursor is not particularly defined, and can be selected according to practical requirements. Particularly, water is selected for washing, wherein, the number of times of washing is not particularly defined, provided that the ions covering the surface of the precursor can be removed.

In the above step a), the temperature and manner of drying are not particularly defined and can be selected according to practical requirements. Particularly, the temperature selected for drying is 100-150° C.

It is known after performing a particle size distribution test on the precursor of the positive electrode material obtained in step a) that the average particle size D50 of the precursor is 2-10 um.

In step b), material I or material II is sintered.

In the above step b), material I is a mixture of the precursor obtained in the first step and a Li source, and material II is a compound of the precursor, the Li source and a M source obtained in the first step.

In the above material I and material II, the Li source is one or more of lithium carbonate, lithium hydrate and lithium nitrate. Particularly, the Li source is lithium carbonate.

In the above material II, the specific types of the compound of the M source is not particularly defined provided that it contains M element. Particularly, M is one of Mg, Ti, Zn, Zr, Al and Nb.

In a preferred embodiment, the compound of M source is an oxide containing M, and the oxide containing M is one or more of magnesium oxide, titanium oxide, zinc oxide, zirconium oxide, aluminium oxide and niobium pentoxide.

In a preferred embodiment, the oxide containing M is one or more of magnesium oxide, zinc oxide, zirconium oxide, aluminium oxide and niobium pentoxide. Further, the oxide containing M is one or more of zinc oxide, zirconium oxide, aluminium oxide and niobium pentoxide. Still further, the oxide containing M is one or more of zirconium oxide and aluminium oxide.

In the above material I, the precursor and the Li source are added in such contents that the ratio of the total molar of metallic elements in the precursor to the molar of Li element in the Li source is Me:Li=1:(0.99-1.2). Further, Me:Li=1:(1-1.2). Still further, Me:Li=1:(1.05-1.15), wherein, Me is a sum of metallic elements in the precursor, i.e., Me=Ni+Co+Mn.

In the above material II, the precursor, the Li source and the oxide containing M are added in such contents that the total molar of the metallic elements in the precursor and the M element in the oxide containing M element to the molar of Li element in the Li source is (Me+M):Li=1:(1+x), wherein, Me+M=Ni+Co+Mn+M.

In the above step b), the temperature for sintering is 820° C. 4000° C. Further, the temperature for sintering is 8504000° C. Still further, the temperature for sintering is 900-1000° C.

In the above first step, the time for sintering is not particularly defined, and can be adjusted according to actual conditions.

In step c), a sample obtained after sintering in step b) is smashed to obtain a sample having an average particle diameter D50 of 2-10 um by sieving, and tempering treatment is carried out to the sample obtained by sieving at a temperature of 500° C.-1000° C.

In the above step c), the smashing manner is not particularly defined, and can be selected according to practical requirements.

In the above step c), the temperature for tempering treatment is 500-900° C. Further, the temperature for tempering treatment is 550-900° C. Still further, the temperature for tempering treatment is 600-900° C.

In a further preferred embodiment, the method for preparing a positive electrode material includes at least the following steps of:
a) adjusting a pH of a solution containing Ni, Mn and Co ions, particularly, adding ammonia water and sodium hydroxide to adjust the pH to 10-12, stirring at a temperature of 40° C.-70° C., and obtaining a precursor through separating, washing and drying; wherein, the temperature for drying is not particularly defined, and can be selected based on practical requirements, and particularly, drying is carried out at a temperature of 100-150° C.
b) evenly mixing a compound containing a Li source and a M source with the precursor obtained in step a), and sintering at a temperature of 820° C.-1000° C.;
c′) smashing a sample obtained after sintering in step b) to obtain a sample having an average particle diameter D50 of 2-10 um by sieving, and performing coating treatment to the sample obtained by sieving;
d′) performing tempering treatment to the sample obtained after the coating treatment in step c′) at a temperature of 500° C.-900° C.;
e) sieving the sample obtained after the tempering treatment in step d′) to obtain a sample having an average particle diameter D50 of 2-10 um, i.e., the positive electrode material.

In the above step a), the obtained precursor has an average particle diameter D50 of 2-10 um, and is spherical or spheroidal.

In the above step b), the mentioned Li source is one or more of lithium carbonate, lithium hydrate and lithium nitrate. Particularly, the Li source is lithium carbonate. The mentioned compound of M source is an oxide containing M, and the oxide containing M is one or more of magnesium oxide, titanium oxide, zinc oxide, zirconium oxide, aluminium oxide and niobium pentoxide. Wherein, the Li source, the compound of M source and the precursor in step a) are added in the same contents as in the above step b).

The sieving and smashing involved in the above step c′) are not particularly defined, and can be selected according to practical requirements.

In the above step c′), the material used for coating is at least one of aluminium oxide, silicon oxide, boron oxide, tungsten oxide, zirconium oxide, titanium oxide, aluminum fluoride and magnesium fluoride. Wherein, the content of the coating layer is such that the content of the coating layer is 0.03-1% of the total weight of the entire material before coating.

In the above step c′), the mentioned coating treatment is a conventional treatment method, for example, it may be methods such as dry coating, liquid coating and vapor deposition.

In the above step c′), the average particle diameter D50 of the sample obtained after sieving is 2-10 um.

This method for preparing the positive electrode material provided in the present application is simple and easy to implement with low costs, and can be applied in industrial manufacture on a large scale.

Another object of the present application is to provide a Li-ion battery, comprising at least one of the positive electrode material provided in the present application and the positive electrode material prepared by the method provided in the present application.

### EXAMPLES

The present application will be further described below through specific examples. However, these examples are only intended for illustration, rather than limitation to the protection scope of the present application.

The agents, materials and equipments used in the following examples are all commercially available unless particularly explained.

In the following examples, comparison examples and test examples:

zirconium oxide: ZrO2; aluminium oxide (Al2O3);

Inductively Coupled Plasma emission spectrometer (ICP), Melvin laser particle size tester (LPS).

### Example One

### I. Synthesis of Precursor

(1) Nickel sulfate, manganese sulfate and cobalt sulfate were added into water to prepare a solution, wherein nickel sulfate, manganese sulfate and cobalt sulfate were added in such contents that the molar ratio of nickel element, manganese element to cobalt element therein was Ni:Mn:Co=5:2.5:2.5;

(2) ammonia water and an aqueous solution of sodium hydroxide was fed into the solution in step (1) to react, and then the solution was stirred at 40° C. to obtain a reaction system containing a precursor of a positive electrode material, wherein, the concentration of the ammonia water was 0.4 mol/L, the concentration of the aqueous solution of sodium hydroxide was 1 mol/L, and the pH of the reaction system was 11.3;

(3) the precursor of the positive electrode material obtained in step (2) was washed with water, filtered and dried in sequence, wherein, the temperature for drying was 100° C.

### II. Preparation of Positive Electrode Material

(1) Lithium carbonate and the precursor obtained in step I were sintered at 950° C., wherein, lithium carbonate and the precursor were added in such contents that the ratio of the molar of lithium element to the molar of the metallic element in the precursor was Li:Me=1.08:1, wherein, Me=Ni+Co+Mn;

(2) the material after sintering in step (1) was smashed, sieved and subjected to tempering treatment in sequence to obtain a positive electrode material D1, wherein the temperature for tempering treatment was 750° C.

It was known after performing an ICP test on D1 obtained instep II that D1 may be represented as Li_{1.08}Ni_{0.5}Co_{0.25}Mn_{0.25}O₂.

It was known after performing a LPS test on the precursor obtained in step I that the particle diameter of the precursor was in normal distribution, and D50 was 3 um.

It was known after performing a LPS test on D1 obtained in step II that the particle diameter of the positive electrode material was in normal distribution, and D50 was 3.5 um.

### Example Two

### I. Synthesis of Precursor

(1) Nickel sulfate, manganese sulfate and cobalt sulfate were added into water to prepare a solution, wherein nickel sulfate, manganese sulfate and cobalt sulfate were added in such contents that the molar ratio of nickel element, manganese element to cobalt element therein was Ni:Mn:Co=5:2.5:2.5;

(2) ammonia water and an aqueous solution of sodium hydroxide was fed into the solution in step (1) to react, and then the solution was stirred at 50° C. to obtain a reaction system containing a precursor of a positive electrode material, wherein, the concentration of the ammonia water was 0.5 mol/L, the concentration of the aqueous solution of sodium hydroxide was 4 mol/L, and the pH of the reaction system was 11.6;

(3) the precursor of the positive electrode material obtained in step (2) was washed with water, filtered and dried in sequence, wherein, the temperature for drying was 90° C.

### II. Preparation of Positive Electrode Material

(1) Lithium carbonate, the precursor obtained in step I and aluminium oxide were mixed and then sintered at 950° C., wherein, lithium carbonate, the precursor and aluminium oxide were added in such contents that the ratio of the molar of lithium element, the total molar of the metallic element in the precursor to the molar of aluminium element in aluminium oxide was Li:Me:Al=1.08:1:0.01, wherein, Me=Ni+Co+Mn;

(2) the material after sintering in step (1) was smashed, sieved and subjected to tempering treatment in sequence to obtain a positive electrode material D2, wherein the temperature for tempering treatment was 750° C.

It was known after performing an ICP test on D2 obtained instep II that D2 may be represented as Li_{1.08}Ni_{0.495}Co_{0.2475}Mn_{0.2475}Al_{0.01}O₂.

It was known after performing a LPS test on the precursor obtained in step I that the particle diameter of the precursor was in normal distribution, and D50 was 4 um. It was known after performing a LPS test on D2 obtained in step II that the particle diameter of the positive electrode material was in normal distribution, and D50 was 4.5 um.

### Example Three

### I. Synthesis of Precursor

(1) Nickel sulfate, manganese sulfate and cobalt sulfate were added into water to prepare a solution, wherein nickel sulfate, manganese sulfate and cobalt sulfate were added in such contents that the molar ratio of nickel element, manganese element to cobalt element therein was Ni:Mn:Co=5:2.5:2.5;

(2) ammonia water and an aqueous solution of sodium hydroxide was fed into the solution in step (1) to react, and then the solution was stirred at 60° C. to obtain a reaction system containing a precursor of a positive electrode material, wherein, the concentration of the ammonia water was 0.3 mol/L, the concentration of the aqueous solution of sodium hydroxide was 3 mol/L, and the pH of the reaction system was 10.9;

(3) the precursor of the positive electrode material obtained in step (2) was washed with water, filtered and dried in sequence, wherein, the temperature for drying was 100° C.

### II. Preparation of Positive Electrode Material

(1) Lithium carbonate, the precursor obtained in step I and zirconium oxide were mixed and then sintered at 950° C., wherein, lithium carbonate, the precursor and zirconium oxide were added in such contents that the ratio of the molar of lithium element, the total molar of the metallic element in the precursor to the molar of zirconium element in zirconium oxide was Li:Me:Zr=1.08:1:0.01, wherein, Me=Ni+Co+Mn;

(2) the material after sintering in step (1) was smashed, sieved and subjected to tempering treatment in sequence to obtain a positive electrode material D3, wherein the temperature for tempering treatment was 750° C.

It was known after performing an ICP test on D3 obtained instep II that D3 may be represented as Li₁₀₈Ni_{0.495} Co_{0.2475}Mn_{0.2475}Zr_{0.01}O₂.

It was known after performing a LPS test on the precursor obtained in step I that the particle diameter of the precursor was in normal distribution, and D50 was 4 um. It was known after performing a LPS test on D3 obtained in step II that the particle diameter of the positive electrode material was in normal distribution, and D50 was 4 um.

### Example Four

### I. Synthesis of Precursor

(1) Nickel sulfate, manganese sulfate and cobalt sulfate were added into water to prepare a solution, wherein nickel sulfate, manganese sulfate and cobalt sulfate were added in such contents that the molar ratio of nickel element, manganese element to cobalt element therein was Ni:Mn:Co=5:2.5:2.5;

(2) ammonia water and an aqueous solution of sodium hydroxide was fed into the solution in step (1) to react, and then the solution was stirred at 60° C. to obtain a reaction system containing a precursor of a positive electrode material, wherein, the concentration of the ammonia water was 1 mol/L, the concentration of the aqueous solution of sodium hydroxide was 5.5 mol/L, and the pH of the reaction system was 11;

(3) the precursor of the positive electrode material obtained in step (2) was washed with water, filtered and dried in sequence, wherein, the temperature for drying was 80° C.

### II. Preparation of Positive Electrode Material

(1) Lithium carbonate and the precursor obtained in step I were mixed evenly and then are sintered at 950° C., wherein, lithium carbonate and the precursor were added in such contents that the ratio of the molar of lithium element to the total molar of the metallic element in the precursor was Li:Me=1.08:1, wherein, Me=Ni+Co+Mn;

(2) the material after sintering in step (1) was smashed and sieved in sequence;

(3) the sieved material was coated with aluminium oxide, and was subjected to tempering treatment at 750° C. to further obtain a positive electrode material D4.

It was known after performing an ICP test on D4 obtained instep II that D4 was Li_{1.08}Ni_{0.5}Co_{0.25}Mn_{0.25}O₂ coated with Al₂O₃, and the coating layer Al₂O₃ was 0.8% of (Li_{1.08}Ni_{0.5}Co_{0.25}Mn_{0.25}O₂) by weight.

It was known after performing a LPS test on the precursor obtained in step I that the particle diameter of the precursor was in normal distribution, and D50 was 3 um.

It was known after performing a LPS test on a sample obtained after sieving in step II that the particle diameter of the sample obtained after sieving was in normal distribution, and D50 was 3.5 um.

It was known after performing a LPS test on D4 obtained in step II that the particle diameter of the positive electrode material D4 was in normal distribution, and D50 was 3.5 um.

### Example Five

### I. Synthesis of Precursor

(1) Nickel sulfate, manganese sulfate and cobalt sulfate were added into water to prepare a solution, wherein nickel sulfate, manganese sulfate and cobalt sulfate were added in such contents that the molar ratio of nickel element, manganese element to cobalt element therein was Ni:Mn:Co=5:2.5:2.5;

(2) ammonia water and an aqueous solution of sodium hydroxide was fed into the solution in step (1) to react, and then the solution was stirred at 65° C. to obtain a reaction system containing a precursor of a positive electrode material, wherein, the concentration of the ammonia water was 0.7 mol/L, the concentration of the aqueous solution of sodium hydroxide was 3.5 mol/L, and the pH of the reaction system was 11;

(3) the precursor of the positive electrode material obtained in step (2) was washed with water, filtered and dried in sequence, wherein, the temperature for drying was 80° C.

### II. Preparation of Positive Electrode Material

(1) Lithium carbonate, the precursor obtained in step I and zirconium oxide were mixed and then sintered at 950° C., wherein, lithium carbonate, the precursor and zirconium oxide were added in such contents that the ratio of the molar of lithium element, the total molar of the metallic element in the precursor to the molar of zirconium element in zirconium oxide was Li:Me:Zr=1.08:1:0.01, wherein, Me=Ni+Co+Mn;

(2) the material after sintering in step (1) was smashed and sieved in sequence;

(3) the sieved material was coated with aluminium oxide, and was subjected to tempering treatment at 750° C. to further obtain a positive electrode material D5. It was known after performing an ICP test on D5 obtained instep II that D5 was Li_{1.08}Ni_{0.495}Co_{0.2475}Mn_{0.2475}Zr_{0.01}O₂ coated with Al₂O₃, and the coating layer Al₂O₃ was 0.8% of (Li_{1.08}Ni_{0.495}Co_{0.2475}Mn_{0.2475}Zr_{0.01}O₂) by weight.

It was known after performing a LPS test on the precursor obtained in step I that the particle diameter of the precursor was in normal distribution, and D50 was 3.0 um.

It was known after performing a LPS test on a sample obtained after sieving in step II that the particle diameter of the sample obtained after sieving was in normal distribution, and D50 was 3.5 um.

It was known after performing a LPS test on D5 obtained in step II that the particle diameter of the positive electrode material was in normal distribution, and D50 was 3.5

### Example Six

### I. Synthesis of Precursor

(1) Nickel sulfate, manganese sulfate and cobalt sulfate were added into water to prepare a solution, wherein nickel sulfate, manganese sulfate and cobalt sulfate were added in such contents that the molar ratio of nickel element, manganese element to cobalt element therein was Ni:Mn:Co=5.0:2.6:2.4;

(2) ammonia water and an aqueous solution of sodium hydroxide was fed into the solution in step (1) to react, and then the solution was stirred at 65° C. to obtain a reaction system containing a precursor of a positive electrode material, wherein, the concentration of the ammonia water was 1.5 mol/L, the concentration of the aqueous solution of sodium hydroxide was 10 mol/L, and the pH of the reaction system was 11;

(3) the precursor of the positive electrode material obtained in step (2) was washed with water, filtered and dried in sequence, wherein, the temperature for drying was 80° C.

### II. Preparation of Positive Electrode Material

(1) Lithium carbonate, the precursor obtained in step I and zirconium oxide were mixed and then sintered at 950° C., wherein, lithium carbonate, the precursor and zirconium oxide were added in such contents that the ratio of the molar of lithium element, the total molar of the metallic element in the precursor to the molar of zirconium element in zirconium oxide was Li:Me:Zr=1.08:1:0.01, wherein, Me=Ni+Co+Mn;

(2) the material after sintering in step (1) was smashed and sieved in sequence;

(3) the sieved material was coated with aluminium oxide, and was subjected to tempering treatment at 750° C. to further obtain a positive electrode material D6. It was known after performing an ICP test on D6 obtained instep II that D6 was Li_{1.08}Ni_{0.495}Co_{0.2375}Mn_{0.2575}Zr_{0.01}O₂ coated with Al₂O₃, and the coating layer Al₂O₃ was 0.8% of (Li_{1.08}Ni_{0.495}Co_{0.2375}Mn_{0.2575}Zr_{0.01}O₂) by weight.

It was known after performing a LPS test on the precursor obtained in step I that the particle diameter of the precursor was in normal distribution, and D50 was 3 um.

It was known after performing a LPS test on a sample obtained after sieving in step II that the particle diameter of the sample obtained after sieving was in normal distribution, and D50 was 3.5 um.

It was known after performing a LPS test on D6 obtained in step II that the particle diameter of the positive electrode material was in normal distribution, and D50 was 3.5 um.

### Example Seven

### I. Synthesis of Precursor

(1) Nickel sulfate, manganese sulfate and cobalt sulfate were added into water to prepare a solution, wherein nickel sulfate, manganese sulfate and cobalt sulfate were added in such contents that the molar ratio of nickel element, manganese element to cobalt element therein was Ni:Mn:Co=4.8:2.6:2.4;

(2) ammonia water and an aqueous solution of sodium hydroxide was fed into the solution in step (1) to react, and then the solution was stirred at 65° C. to obtain a reaction system containing a precursor of a positive electrode material, wherein, the concentration of the ammonia water was 0.5 mol/L, the concentration of the aqueous solution of sodium hydroxide was 4 mol/L, and the pH of the reaction system was 10;

(3) the precursor of the positive electrode material obtained in step (2) was washed with water, filtered and dried in sequence, wherein, the temperature for drying was 80° C.

### II. Preparation of Positive Electrode Material

(1) Lithium carbonate, the precursor obtained in step I and aluminium oxide were mixed and then sintered at 950° C., wherein, lithium carbonate, the precursor and zirconium oxide were added in such contents that the ratio of the molar of lithium element, the total molar of the metallic element in the precursor to the molar of aluminium element in aluminium oxide was Li:Me:Al=1.08:1:0.03, wherein, Me=Ni+Co+Mn;

(2) the material after sintering in step (1) was smashed and sieved in sequence;

(3) the sieved material was coated with aluminium oxide, and was subjected to tempering treatment at 750° C. to further obtain a positive electrode material D7. It was known after performing an ICP test on D7 obtained instep II that D7 was Li_{1.08}Ni_{0.475}Co_{0.2375}Mn_{0.2575}Al_{0.03}O₂ coated with Al₂O₃, and the coating layer Al₂O₃ was 0.8% of (Li_{1.08}Ni_{0.475}Co_{0.2375}Mn_{0.2575}Al_{0.03}O₂) by weight.

It was known after performing a LPS test on the precursor obtained in step I that the particle diameter of the precursor was in normal distribution, and D50 was 3.5 um. It was known after performing a LPS test on a sample obtained after sieving in step II that the particle diameter of the sample obtained after sieving was in normal distribution, and D50 was 3.5 um.

It was known after performing a LPS test on D7 obtained in step II that the particle diameter of the positive electrode material was in normal distribution, and D50 was 3.5 um.

### Example Eight

### I. Synthesis of Precursor

(1) Nickel sulfate, manganese sulfate and cobalt sulfate were added into water to prepare a solution, wherein nickel sulfate, manganese sulfate and cobalt sulfate were added in such contents that the molar ratio of nickel element, manganese element to cobalt element therein was Ni:Mn:Co=5.1:2.4:2.5;

(2) ammonia water and an aqueous solution of sodium hydroxide was fed into the solution in step (1) to react, and then the solution was stirred at 70° C. to obtain a reaction system containing a precursor of a positive electrode material, wherein, the concentration of the ammonia water was 1.5 mol/L, the concentration of the aqueous solution of sodium hydroxide was 3 mol/L, and the pH of the reaction system was 11;

(3) the precursor of the positive electrode material obtained in step (2) was washed with water, filtered and dried in sequence, wherein, the temperature for drying was 90° C.

### II. Preparation of Positive Electrode Material

(1) Lithium carbonate, the precursor obtained in step I and aluminium oxide were mixed and then sintered at 950° C., wherein, lithium carbonate, the precursor and zirconium oxide were added in such contents that the ratio of the molar of lithium element, the total molar of the metallic element in the precursor to the molar of aluminium element in aluminium oxide was Li:Me:Al=1.08:1:0.01, wherein, Me=Ni+Co+Mn;

(2) the material after sintering in step (1) was smashed and sieved in sequence;

(3) the sieved material was coated with aluminium oxide, and was subjected to tempering treatment at 750° C. to further obtain a coated material.

It was known after performing an ICP test on D8 obtained instep II that D8 was Li_{1.08}Ni_{0.505}Co_{0.2475}Mn_{0.2375}Al_{0.01}O₂ coated with Al₂O₃, and the coating layer Al₂O₃ was 0.8% of (Li_{1.08}Ni_{0.505}Co_{0.2475}Mn_{0.2375}Al_{0.01}O₂) by weight.

It was known after performing a LPS test on the precursor obtained in step I that the particle diameter of the precursor was in normal distribution, and D50 was 3.0 um.

It was known after performing a LPS test on a sample obtained after sieving in step II that the particle diameter of the sample obtained after sieving was in normal distribution, and D50 was 3.5 um.

It was known after performing a LPS test on D8 obtained in step II that the particle diameter of the positive electrode material was in normal distribution, and D50 was 3.5 um.

### Example Nine

### I. Synthesis of Precursor

(1) Nickel sulfate, manganese sulfate and cobalt sulfate were added into water to prepare a solution, wherein nickel sulfate, manganese sulfate and cobalt sulfate were added in such contents that the molar ratio of nickel element, manganese element to cobalt element therein was Ni:Mn:Co=5.1:2.4:2.5;

(2) ammonia water and an aqueous solution of sodium hydroxide was fed into the solution in step (1) to react, and then the solution was stirred at 70° C. to obtain a reaction system containing a precursor of a positive electrode material, wherein, the concentration of the ammonia water was 1 mol/L, the concentration of the aqueous solution of sodium hydroxide was 4 mol/L, and the pH of the reaction system was 11;

(3) the precursor of the positive electrode material obtained in step (2) was washed with water, filtered and dried in sequence, wherein, the temperature for drying was 90° C.

### II. Preparation of Positive Electrode Material

(1) Lithium carbonate, the precursor obtained in step I and aluminium oxide were mixed and then sintered at 950° C., wherein, lithium carbonate, the precursor and zirconium oxide were added in such contents that the ratio of the molar of lithium element, the total molar of the metallic element in the precursor to the molar of aluminium element in aluminium oxide was Li:Me:Al=1.08:1:0.01, wherein, Me=Ni+Co+Mn;

(2) the material after sintering in step (1) was smashed and sieved in sequence;

(3) the sieved material was coated with zirconium oxide, and was subjected to tempering treatment at 750° C. to further obtain a positive electrode material D9. It was known after performing an ICP test on D9 obtained instep II that D9 was Li_{1.08}Ni_{0.505}Co_{0.2475}Mn_{0.2375}Al_{0.01}O₂ coated with ZrO₂, and the coating layer ZrO₂ was 1% of (Li_{1.08}Ni_{0.505}Co_{0.2475}Mn_{0.2375}Al_{0.01}O₂) by weight.

It was known after performing a LPS test on the precursor obtained in step I that the particle diameter of the precursor was in normal distribution, and D50 was 3.0 um.

It was known after performing a LPS test on a sample obtained after sieving in step II that the particle diameter of the sample obtained after sieving was in normal distribution, and D50 was 3.5 um.

It was known after performing a LPS test on D9 obtained in step II that the particle diameter of the positive electrode material was in normal distribution, and D50 was 3.5 um.

### Comparison Example One

### I. Synthesis of Precursor

(1) Nickel sulfate, manganese sulfate and cobalt sulfate were added into water to prepare a solution, wherein nickel sulfate, manganese sulfate and cobalt sulfate were added in such contents that the molar ratio of nickel element, manganese element to cobalt element therein was Ni:Mn:Co=5:3:2;

(2) ammonia water and an aqueous solution of sodium hydroxide was fed into the solution in step (1) to react, and then the solution was stirred at 40° C. to obtain a reaction system containing a precursor of a positive electrode material, wherein, the concentration of the ammonia water was 0.5 mol/L, the concentration of the aqueous solution of sodium hydroxide was 6 mol/L, and the pH of the reaction system was 11;

(3) the precursor of the positive electrode material obtained in step (2) was washed with water, filtered and dried in sequence, wherein, the temperature for drying was 100° C.

### II. Preparation of Positive Electrode Material

(1) Lithium carbonate and the precursor obtained in step I were mixed evenly and then are sintered at 920° C., wherein, lithium carbonate and the precursor were added in such contents that the ratio of the molar of lithium element to the total molar of the metallic element in the precursor was Li:Me=1.08:1, wherein, Me=Ni+Co+Mn;

(2) the material after sintering in step (1) was smashed, sieved and subjected to tempering treatment in sequence to obtain a positive electrode material D10, wherein the temperature for tempering treatment was 750° C.

It was known after performing an ICP test on D10 obtained instep II that D10 may be represented as Li_{1.08}Ni_{0.05}Co_{0.2}Mn_{0.3}O₂ (NCM523).

It was known after performing a LPS test on the precursor obtained in step I that the particle diameter of the precursor was in normal distribution, and D50 was 3.0 um. It was known after performing a LPS test on D10 obtained in step II that the particle diameter of the precursor was in normal distribution, and D50 was 3.5 um.

### Test Example

### X-Ray Diffraction Analysis

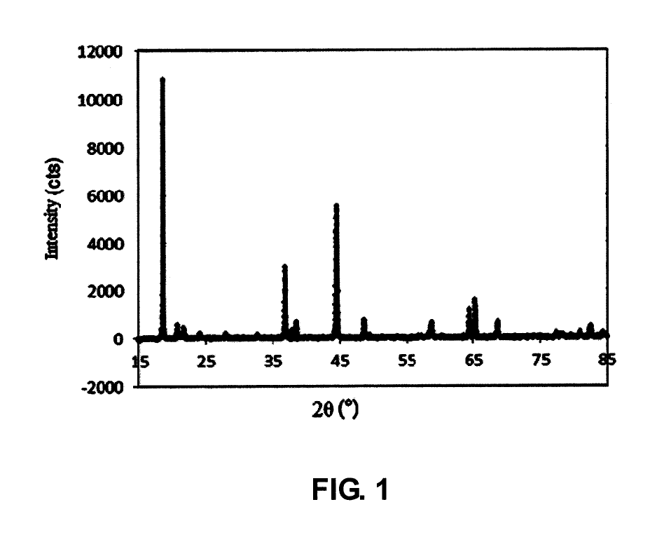

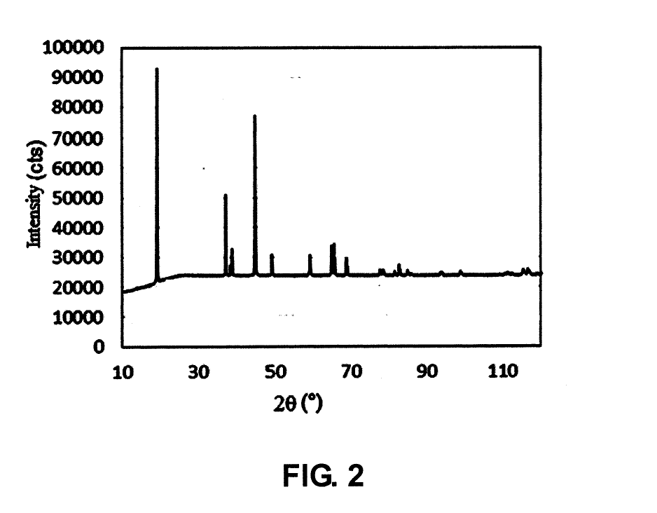

X-ray diffraction analysis was performed respectively on the positive electrode materials D1 and D10 obtained in Example One and Comparison Example One, obtaining XRD spectrograms, which are respectively as shown in FIG. 1 and FIG. 2.

It can be seen from comparison analysis on FIG. 1 and FIG. 2 that all positive electrode materials obtained in the present application have a crystal structure, and meanwhile it can be seen from sharp diffraction peaks that the obtained positive electrode materials have good crystallinity.

In addition, it can be seen from comparison analysis on FIG. 1 and FIG. 2 that there are peak (003) of layered characteristic peak 18.68° and peak (104) of 44.52°, as well as a series of small peaks of superlattice characteristic peaks 20-25° in FIG. 1.

Therefore, it can be seen that the positive electrode material provided in the present application has a superlattice structure of [\sqrt{3}×\sqrt{3}]R30° type.

### Scanning Electron Microscope Analysis (SEM)

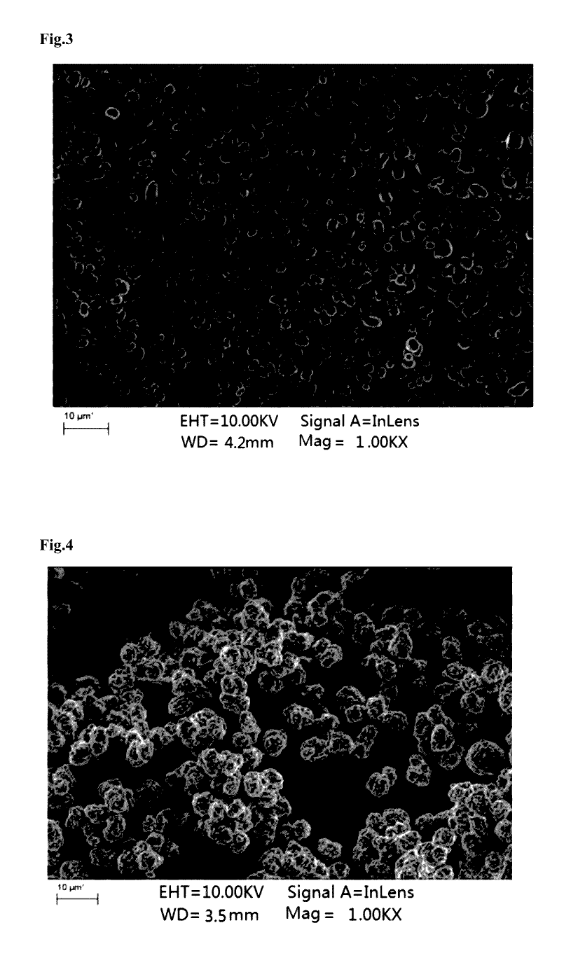

Scanning electron microscope analysis was performed respectively on the positive electrode materials D1 and D10 obtained in Example One and Comparison Example One, obtaining SEM images, which are respectively as shown in FIG. 3 and FIG. 4.

It can be seen from comparison analysis on FIG. 3 and FIG. 4 that there are a large number of particles with a uniform shape, a compact structure and an even distribution in FIG. 3, while particles agglomerate and particle distribution is not even in FIG. 4. Therefore, all the positive electrode materials obtained in the present application are mono-like particles that are evenly distributed with little agglomeration.

### Test on Ratio of Primary Particle Average Particle Diameter D50/Secondary Particle Average Particle Diameter D50

Tests were performed on all positive electrode materials obtained in the examples and comparison example by a method of combination of SEM and LPS. The results are as below in Table 1.

TABLE 1

| | Primary Particle Average Particle |
|---|---|
| | Diameter/Secondary Particle Average Particle |
| Material No. | Diameter (D₁/D₂) |
| D1 | 0.9 |
| D2 | 0.85 |
| D3 | 0.7 |
| D4 | 0.65 |
| D5 | 0.78 |
| D6 | 0.93 |
| D7 | 0.65 |
| D8 | 0.75 |
| D9 | 0.85 |
| D10 | 0.2 |

### Test on Electrochemical Property

### I. Preparation of Li-Ion Batteries

Li-ion batteries 1-10 were prepared through the following processes in sequence by respectively using the positive electrode materials obtained in Examples One-Nine and Comparison Example One as the positive electrode materials in positive electrodes: winding a positive electrode, a negative electrode and a Li battery separator, encapsulating with an aluminium plastic film, injecting an electrolyte, sealing, and obtaining a Li-ion battery through processes including standing, hot and cold pressing, formation, clamp, grading and so on.

### II. Tests on Cycle Performance and Initial Charge-Discharge Efficiency

The following tests were performed respectively on Li-ion batteries 1-10.

The Li-ion battery was charged to 4.4V with a constant current at a rate of 0.5 C at 45° C., and then was charged with a constant voltage till the current was 0.05 C, and afterwards was discharged to 3.0V at a constant current of 0.5 C. The initial charge-discharge efficiency was obtained through detection. In addition, the capacity retention ratios of the battery after 50 times of cycles were calculated respectively according to the above charging/discharging cycle conditions. The results are shown in the following Table 2. Wherein, initial charge-discharge efficiency=(first discharge capacity/first charge capacity)×100%, retention ratio after 50 times of cycles=fiftieth discharge capacity/first discharge capacity)×100%

TABLE 2

| | | initial | retention ratio |
|---|---|---|---|
| | Positive electrode | charge-discharge | after 50 times |
| Li-ion battery No. | material No. | efficiency % | of cycles/% |
| Li-ion battery 1 | D1 | 91.6 | 99.6 |
| Li-ion battery 2 | D2 | 89.3 | 97.2 |
| Li-ion battery 3 | D3 | 89.2 | 97.4 |
| Li-ion battery 4 | D4 | 89.4 | 97.6 |
| Li-ion battery 5 | D5 | 88.9 | 98.1 |
| Li-ion battery 6 | D6 | 88.4 | 98.3 |
| Li-ion battery 7 | D7 | 88.4 | 98.4 |
| Li-ion battery 8 | D8 | 90.4 | 97.4 |
| Li-ion battery 9 | D9 | 88.2 | 94 |
| Li-ion battery 10 | D10 | 85.1 | 88.2 |

It can be seen from Table 2 that after the positive electrode material provided in the present application is applied to the Li-ion battery, the initial charge-discharge efficiency and the retention ratio after 50 times of cycles of the Li-ion battery have been greatly improved.

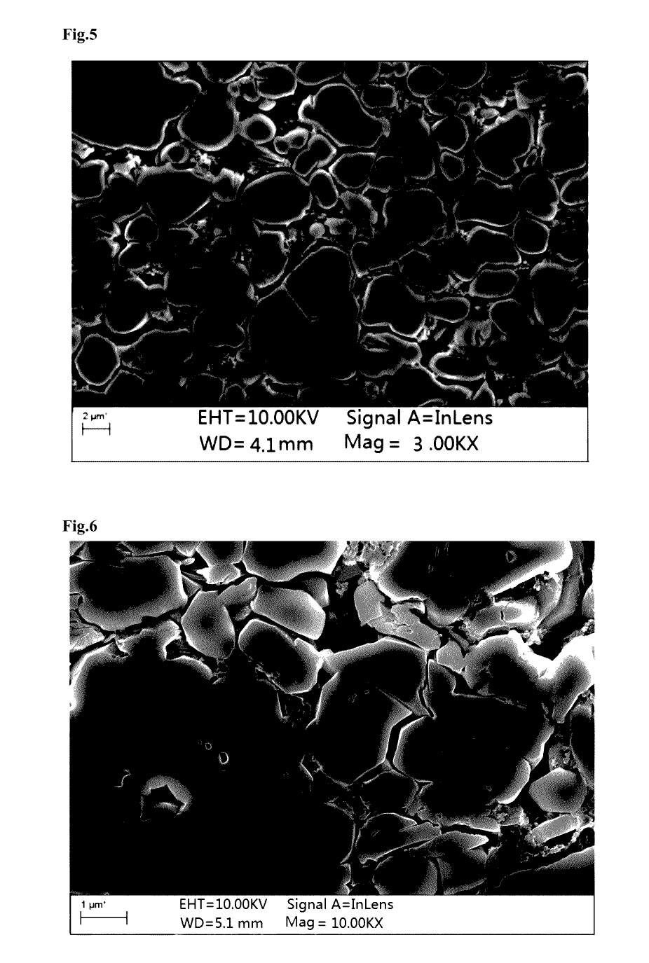

Moreover, a scanning electron microscope (SEM) test was carried out on the positive plates in the Li-ion battery 1 and Li-ion battery 10 after 50 times of cycles. The results are as shown in FIG. 5 and FIG. 6.

It can be seen from FIG. 5 and FIG. 6 that there are a large number of particles with an even distribution, a uniform size and a sphere shape in FIG. 5, and there are a large number of broken pole pieces of tabular particles in FIG. 6.

Therefore, it can be concluded that after the positive electrode material provided in the present application is applied to a Li-ion battery, few particles broke after multiple times of charges and discharges.

The descriptions above are merely a few examples of this application, which are not intended to limit this application in any way. Although this application is disclosed as above in connection with preferred examples, this application is not limited thereto. Some variations and modifications made by any person of skill in the art based on the technical contents disclosed above without departing from the scope of the technical solution of this application provide equivalent embodiments of this application, which also fall within the scope of the technical solution.

1. A positive electrode material containing a crystal with a superlattice structure having a chemical composition as shown by Formula I:
Li₁₊ₓNiₐCo_{b}Mn_{c}M_{d}O₂ Formula I
in which, −0.01≦x≦0.2, 1.8≦a/c≦2.2, 0.9≦b/c≦1.1, 0≦d≦0.1; and M is selected from at least one of Mg, Ti, Zn, Zr, Al and Nb.

2. The positive electrode material according to claim 1, wherein, a ratio of an average particle diameter D50 of primary particles of the positive electrode material to an average particle diameter D50 of secondary particles of the positive electrode material is D₁/D₂=0.5-1.

3. The positive electrode material according to claim 1, wherein, the superlattice structure is a superlattice structure of [\sqrt{3}×\sqrt{3}]R30° type.

4. The positive electrode material according to claim 1, wherein, there is a coating layer outside the crystal.

5. The positive electrode material according to claim 4, wherein, the coating layer includes at least one of aluminium oxide, silicon oxide, boron oxide, tungsten oxide, zirconium oxide, titanium oxide, aluminum fluoride and magnesium fluoride.

6. A method for preparing a positive electrode material according to claim 1, comprising at least the following steps of:
a) adjusting a pH of a solution containing Ni, Mn and Co ions to 10-12, stirring under a temperature of 40° C.-70° C., separating, washing and drying to obtain a precursor;
b) evenly mixing a compound containing a Li source and a M source with the precursor obtained in step a), and sintering at a temperature of 820° C.-1000° C.;
c) smashing a sample obtained after sintering in step b) to obtain a sample having an average particle diameter D50 of 2-10 um by sieving, and performing tempering treatment to the sample obtained by sieving at a temperature of 500° C.-900° C.;
d) sieving the sample obtained after the tempering treatment in step c) to obtain a sample having an average particle diameter D50 of 2-10 um, i.e., the positive electrode material.

7. A method for preparing a positive electrode material according to claim 4, comprising at least the following steps of:
a) adjusting a pH of a solution containing Ni, Mn and Co ions to 10-12, stirring under a temperature of 40° C.-70° C., separating, washing and drying to obtain a precursor;
b) evenly mixing a compound containing a Li source and a M source with the precursor obtained in step a), and sintering at a temperature of 820° C.-1000° C.;
c′) smashing a sample obtained after sintering in step b) to obtain a sample having an average particle diameter D50 of 2-10 um by sieving, and performing coating treatment to the sample obtained by sieving;
d′) performing tempering treatment to the sample obtained after the coating treatment in step c′) at a temperature of 500° C.-900° C.;
e) sieving the sample obtained after the tempering treatment in step d′) to obtain a sample having an average particle diameter D50 of 2-10 um, i.e., the positive electrode material.

8. The method for preparing a positive electrode material according to claim 6, wherein, the precursor obtained n step a) has an average particle diameter D50 of 2-10 um, and is spherical or spheroidal.

9. A Li-ion battery, comprising at least one of:
a positive electrode material containing a crystal with a superlattice structure having a chemical composition as shown by Formula I:
Li₁₊ₓNiₐCo_{b}Mn_{c}M_{d}O₂ Formula I
in which, −0.01≦x≦0.2, 1.8≦a/c≦2.2, 0.9≦b/c≦1.1, 0≦d≦0.1; and M is selected from at least one of Mg, Ti, Zn, Zr, Al and Nb; and
a positive electrode material prepared by at least the following steps of:
a) adjusting a pH of a solution containing Ni, Mn and Co ions to 10-12, stirring under a temperature of 40° C.-70° C., separating, washing and drying to obtain a precursor;
b) evenly mixing a compound containing a Li source and a M source with the precursor obtained in step a), and sintering at a temperature of 820° C.-1000° C.;
c) smashing a sample obtained after sintering in step b) to obtain a sample having an average particle diameter D50 of 2-10 um by sieving, and performing tempering treatment to the sample obtained by sieving at a temperature of 500° C.-900° C.;
d) sieving the sample obtained after the tempering treatment in step c) to obtain a sample having an average particle diameter D50 of 2-10 um, i.e., the positive electrode material.
